(19) United States
(12) Patent Application Publication
(10) Pub. No.: US 2005/0214635 A1
(43) Pub. Date: Sep. 29, 2005

(54) Microbattery and systems using microbattery

(76) Inventor: Ki Bang Lee, Seoul (KR)

Correspondence Address: DARBY & DARBY P.C., P. O. BOX 5257, NEW YORK, NY, 10150-5257, US

(21) Appl. No.: 10/507,968

(22) PCT Filed: Mar. 18, 2003
(86) PCT No.: PCT/KR03/00534

§ 371 Date: Sep. 13, 2004

(30) Foreign Application Priority Data
Mar. 18, 2002 (KR) 10-2002-0015205

(51) Int. Cl. H01M 6/38; H01M 2/12; H01M 4/46

(52) U.S. Cl. 429/115; 429/82; 429/231.6

(57) ABSTRACT

Microbatteries based on liquid electrolyte are provided suitable for disposable microsystems including MEMS and bioMEMS. Systems using disposable and on-demand microbattery are also provided. Microbattery consists of a substrate, an anode supplying electrons when the anode contact to an electrolyte, a sealed liquid pocket including liquid mixture of an electrolyte and a cathode, a pressing means to generate pressure in said sealed liquid pocket, breaking means that is easily torn or removed by the pressure generated in said, liquid pocket, conducting electron collectors collecting electron to assist cathodic reaction and a cavity. Surface tension drives said liquid mixture into said cavity after tearing said breaking means, then electro-chemical reaction occurs to activate the microbattery. Water or blood activated microbattery is also provided for bioMEMS.

### BRIEF DESCRIPTION OF THE DRAWINGS

FIG. 1-1 is a perspective view of a microbattery embodying the principles of this invention.

FIG. 1-2 is a side view of a microbattery (cross section A of FIG. 1-1).

FIG. 1-3 is a working principle of a microbattery showing in FIG. 1-2.

FIGS. 2, 3 and 4 are embodiments using present invention concept.

FIG. 5 is a system using microbattery of the invention.

FIG. 6 is a cross section of the system of FIG. 5 (cross section B of FIG. 5).

FIG. 7 is a DNA chip system using present invention concept.

FIG. 8 is a signal flow of FIG. 7.

FIG. 9 is another embodiment of DNA chip system.

FIG. 10 is a signal flow of FIG. 9.

FIGS. 11-1, 11-2 and 11-3 are embodiments of blood-examining systems with test needle.

FIG. 12 is a schematic diagram of better needle.

FIGS. 13, 14 and 15 are embodiments of blood-examining systems with different needles.

FIG. 16 is a stacked microbattery fabricated on a substrate.

FIGS. 17-1 and 17-2 are drug delivery systems embodying the systems of the invention.

### BACKGROUND OF THE INVENTION

1. Field of the Invention

The present invention relates to a microbattery and systems using microbatteries that can be used for MEMS (Micro Electro Mechanical Systems) or bioMEMS.

2. Description of the Related Arts

Recently, many researchers and companies have done research on MEMS (Micro Electro Mechanical Systems) or micromachine. Much achievement in the MEMS or bioMEMS area has been done. Currently, researchers are interested in lab-on-a-chip, DNA chip, optical microsystems and microtransceiver because these have big potential market in Microsystems in the future. Using batch process such as bulk and surface micromachining technology, these MEMS or bioMEMS devices can be easily fabricated with microactuator, microsensor and circuits on a substrate. For example, lab-on-a-chip can be used to do several experiments using a droplet of a liquid on a chip at the same time. These technologies will play an important role in the future.

Currrent MEMS or bioMEMS technologies have a bottleneck of energy source. Although Microsystems such as lab-on-a-chip or DNA chip are fabricated on a chip, the current microsystems need electrical energy from outside conventional battery or light energy for detection.

### SUMMARY OF THE INVENTION

It is an objective of the present invention to provide a microbattery and systems using a microbattery. The microbattery or systems can be activated by a sealed electrolyte or even water obtained blood. Disposable system with microbattery can be fabricated on a substrate by using several technologies including surface micromachining technology, bulk micromachining technology, conventional technology, etc.

To achieve the above objective, a microbattery including in combination consists of: a substrate; an anode supplying electrons when the anode contact to an electrolyte; a sealed liquid pocket including liquid mixture of an electrolyte and a cathode; a pressing means to generate pressure in said sealed liquid pocket; a breaking means that is easily torn or removed by the pressure generated in said; liquid pocket; conducting electron collectors collecting electron to assist cathodic reaction; a cavity which said anode, said electron collector, and said breaking means contact to, where surface tension drives said liquid mixture into said cavity after tearing said breaking means, then electro-chemical reaction occurs to activate the microbattery.

In addition to this invention, the following in any combination may provide better microbattery.
said cavity has at least one air holes to remove air or gas inside said cavity when said microbattery is activated.
conductors are connected to said anode and electron collector to guide the generated electron to an outside circuit.
said anode, said electron collector, said sealed liquid pocket, said breaking means, said pressing mean, etc are fabricated on a substrate.
said cavity between said anode and said electron collector has a porous or fibrous absorber to absorb said liquid mixture.
said liquid mixture consists of the sulfuric acid and hydrogen peroxide.
said liquid mixture includes KOH.

Another preferred microbattery in combination consists of: a substrate; an anode supplying electrons when the anode contact to an electrolyte; a cathode; a sealed pocket including liquid electrolyte; a pressing means to generate pressure in said sealed pocket; a breaking means that is easily torn or removed by the pressure generated in said pocket; a cavity which said anode, said electron collector, and said breaking means contact to, where surface tension drives said liquid electrolyte into said cavity after tearing said breaking means, then electrochemical reaction occurs to activate the microbattery.

In addition to this invention, the following in any combination may provide better microbattery.
conducting material is added to said cathode to reduce the internal resistance.
said cavity has at least one air holes to remove air or gas inside said cavity when said microbattery is activated.
a electron collector and conductor are connected to said anode and cathode to guide the generated electron to an outside circuit.
said anode, said cathode, said sealed pocket, said breaking means, said pressing mean, etc are fabricated on a substrate.
said cavity between said anode and said electron collector has a porous or fibrous absorber to absorb said liquid mixture.
said electrolyte is water.
said anode is magnesium and cathode is zinc chloride.

Another preferred microbattery in combination consists of: a substrate; an anode supplying electrons when the anode contact to an electrolyte; a cathode; a solid electrolyte that can be melted when the solid electrolyte is heated up; a cavity in which said melted electrolyte can contact said anode and said cathode, where surface tension drives said melted electrolyte into said cavity after heating up, then electro-chemical reaction occurs to activate the microbattery.

A system including at least one microbattery consists of: a substrate; an anode supplying electrons when the anode contact to an electrolyte; a cathode; a sealed pocket including liquid electrolyte; a pressing means to generate pressure in said sealed pocket; a breaking means that is easily torn or removed by the pressure generated in said pocket; a cavity which said anode, said electron collector, and said breaking means contact to, where the microbattery can supply electrical energy to said system after activation.

In addition to this invention, the following in any combination may provide better system.
said electrolyte includes said cathode.
an area of said substrate has said microbattery, other area of said substrate has a diagnostic chip or system.
a side of said substrate has said microbattery, another side of said substrate has other part except said microbattery.
said diagnostic chip consists of a display part, a control part, and a diagnostic part which are activated by said microbattery.
said system has an input part such key pad to put data.
a memory part and a communication part are added to process the data and communicate with outside.
said system communicates with an outside system by using wireless transceiver.
said system has a needle to extract a test liquid or blood.
said system has a stopper to control the pricking depth.
there are a pair of saw teeth between the needle and a place facing the needle to preventing said needle from remaining on the skin when said system is taken out.
said system has a breaking means or a membrane, then said braking means is torn or removed when the skin is pricked with said needle to obtain blood or test liquid inside.
a soluble breaking means is inside said needle, said breaking means is removed to transport blood or test liquid inside.
said diagnostic part is vacuum, then blood or test liquid can be easily transport into inside by the pressure difference when said breaking means is removed.
in addition to said diagnostic part, said system has a prescription part to inject drug if needed.
said system has one more needle for injection of drug.

A system includes: a substrate; an energy consuming part consisting of electrical components, MEMS device, etc on a side of said substrate; a power supplying part that generates electrical energy from an energy source such chemical and optical means, where energy generated from said power supplying part flows to said energy consuming part.

In addition to this invention, the following in any combination may provide better system.
said power supplying part is battery converting chemical energy to electrical energy.
surface tension drives an electrolyte from a position to another position to activate the battery.
said electrolyte include a cathode material in it.
said anode, said cathode, and said electrolyte are stacked on a substrate.
said power supplying part is Zinc-Air battery to release electrical energy.

A system consists of: an actuating means; a control means to control said actuating means; an energy supplying means to supply electrical energy to said actuating means and said control means, where an electro-chemical reaction in said energy supplying means occurs to supply electrical energy to said actuating means and said control means when an electrolyte is supplied.

In addition to this invention, the following in any combination may provide better system.
said electrolyte is water or a liquid including water.
said electrolyte is an acid.
said system is drug delivery system in which an acid or water from human body activates energy supplying means to supply electrical energy to drug delivery device with said actuating mean, and said control means.

### DESCRIPTION OF THE PREFERRED EMBODIMENTS

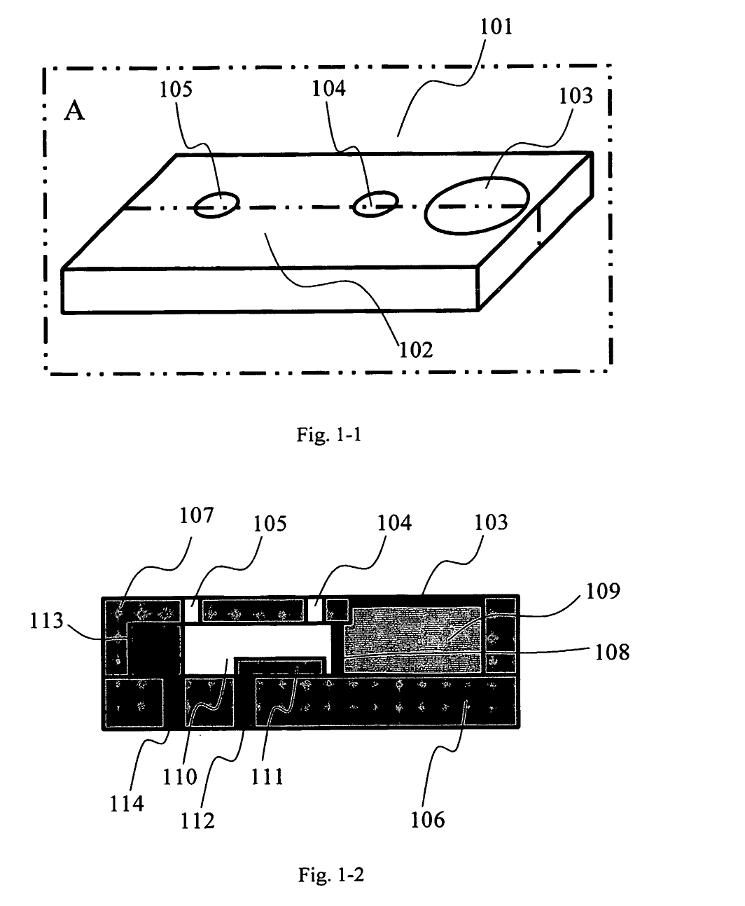

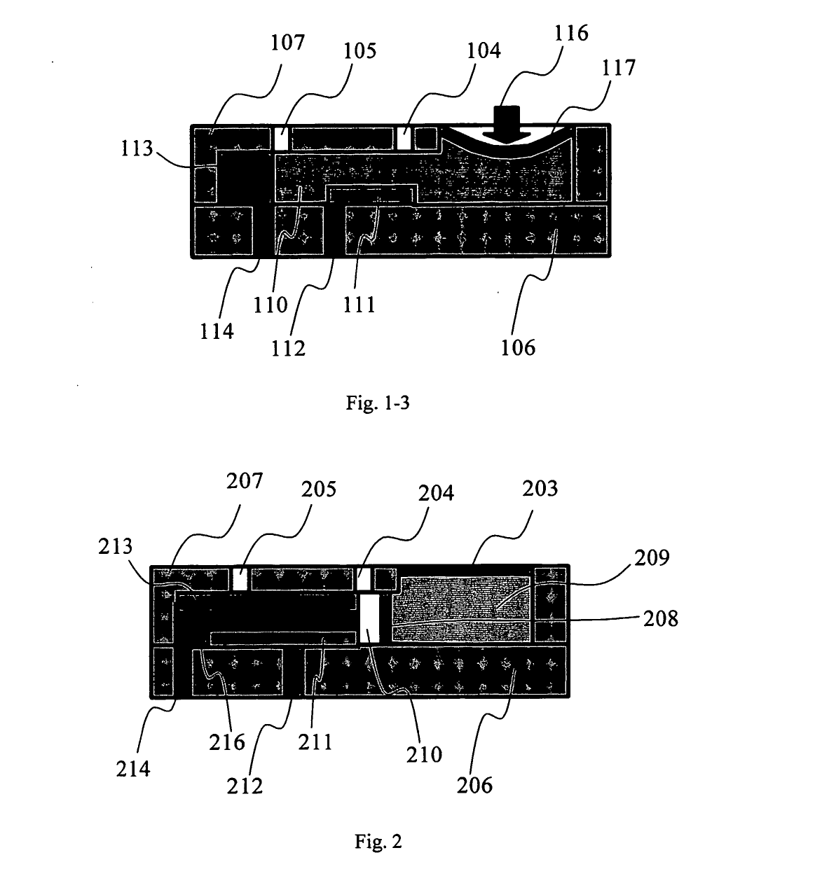

FIGS. 1-1, 1-2, and 1-3 show perspective view, side view, and working principle of a microbattery 101 embodying of the invention. In a perspective view FIG. 1-1, microbattery 101 consists of activation button 103 and several air hole 104 and 105 on a body 102. FIG. 1-2 is a side view of a microbattery along cross section A of FIG. 1-1 to show the microbattery detail. The microbattery 101 consists of a upper plate 107 mounted on the substrate 106, an activation button 103 on the upper plate 107, a breaking means 108 such as a membrane placed between the upper plate 107 and the substrate 106 that is used to store an electrolyte 109 and is torn away when it is needed to break, a cavity 110 between the upper plate 107 and the substrate 106, an electron collector 111 placed in the cavity 110 on the substrate 106, an anode 113 supplying electrons after reaction to the electrolyte 109, electrical conductors 112 and 114 for outside circuit to contact the electron collector 111 and the anode 113, and air holes 104 and 105 on the upper plate 107 to remove the inside air in the cavity.

Although several chemicals or materials are used for suitable operation, chemicals or materials are chosen at this time to give clear explanation. The substrate 106 is a silicon substrate; the electron collector 111 is thin gold layer that is usually used for electrical contact or pad in MEMS fabrication process. Zinc is selected for the anode 113. The electrolyte 109 consists of a mixture of sulfuric acid and hydrogen peroxide. An electrolyte-resistant membrane such as plastic film is used as the activation button 103.

Using the microbattery just mentioned in FIGS. 1-1 and 1-2, working principle of a present microbattery is described in FIG. 1-3. The microbattery 101 has the sealed electrolyte 109 and zinc anode 113, and thin gold layer 111 as electron collector. When electrical energy is needed, a user presses the activation button 103, in turn, pressure in the electrolyte is generated, and finally the pressure breaks the membrane 108. The surface tension of the electrolyte 109 drives the electrolyte into the cavity 110 while the air in the cavity goes out through the air holes 104 and 105. After that, the electrolyte 109 can contact the zinc anode 113 and the thin gold layer as the electron collector 111 to give the following electro-chemical reactions of the microbattery. The electro-chemical reaction of the microbattery at the zinc can be expressed as the anodic reaction (oxidation):
Zn+2H⁺+SO₄⁻→Zn SO₄+2e⁻+2H⁺ (1)
the cathodic reaction (reduction) is represented as:
H₂O₂+2e⁻+2H⁺2H₂O (2)
and the overall reaction is:
Zn+H₂SO₄+H₂O₂→Zn SO₄+2H₂O (3)
The electrons, generated from the zinc 113, flows to hydrogen peroxide in the electrolyte through the conductor 114, an outside circuit (not drawn in the figures), another conductor 112, and electron collector 111. It means that the zinc 113 is oxidized to supply electrons to the outside circuit and the hydrogen peroxide collects electron from the outside circuit. Therefore the microbattery 101 can supply electrical energy to circuits. The theoretical voltage of 2.5V is obtained but the measured voltage is 1.5.

In the previous explanation, Zinc is selected as the anode 113, the electrolyte 109 consists of sulfuric acid and hydrogen peroxide and gold layer is used as an electron collector. Generally, any liquid reacting to chemicals such as anode or cathode, several anode and cathode can be used for the microbattery of this invention. For example, ZnCl₂ solution for electrolyte, zinc as anode, and MnO₂ with carbon for cathode can be used for a microbattery.

For long shelf life, chemical electrolyte is not suitable for microbattery because the encapsulated electrolyte maybe degrades or reacts to other material such as capsule or plastic material. For stable and safe microbattery, water can be used for water-activated microbattery. For example, the water-activated disposable microbattery consists of magnesium as the anode, cuprous chloride as the cathode, a cavity between the anode and cathode, and encapsulated water. This battery is stable and safe and has long shelf life because water is stable. When we press the encapsulated water, surface tension and pressure drive the water into the cavity for reaction and the electro-chemical occurs to supply electrical energy. Consider a rain-activated battery that consist of magnesium as the anode and cuprous chloride separated from the anode by a predetermined distance fabricated on a substrate. In this case, surface tension helps rain cover the anode and the cathode to generate electrical energy.

Using FIGS. 1-1, 1-2 and 1-3, basic working principle of the invention was described. This microbattery structure has internal resistance. For small internal resistance, it is preferred to place a separator between anode and electron collector. FIG. 2 shows an embodiment of the microbattery with a separator.

The microbattery consists of a upper plate 207 mounted on the substrate 206, an activation button 203 on the upper plate 207, a breaking means 208 such as a membrane placed between the upper plate 207 and the substrate 206 that is used to store an electrolyte 209 and is torn away when it is needed to break, a cavity 210 between the upper plate 207 and the substrate 206, stacked layers anode 213/separator 216/electron collector 211 between the upper plate 207 and the substrate 206, electrical conductors 212 and 214 for outside circuit, and air holes 204 and 205. The separator 216 has porous or fibrous structure that absorb easily electrolyte and avoid electrical short between the anode 213 and the electron collector 211.

As explained in FIG. 1, microbattery is described using thin gold layer as electron collector 211, zinc as the anode 213, sulfuric acid with hydrogen peroxide as electrolyte 209.

When electrical energy is needed, a user presses the activation button 203, in turn, pressure in the electrolyte is generated, and finally the pressure breaks the membrane 208. The electrolyte move into the cavity 210 and the separator 216 absorbs the electrolyte. After that, the electro-chemical reaction of Eq. 3 occurs to supply electrical energy.

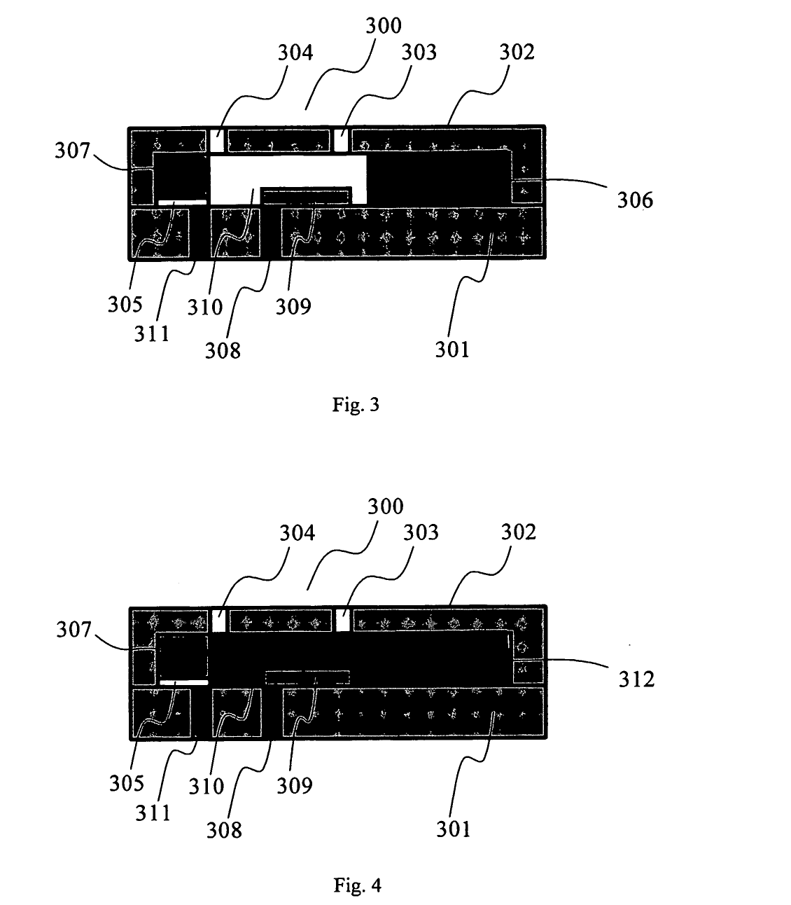

FIG. 3 shows another embodiment of the invention using a solid electrolyte. Heat-activated microbattery 300 consists of a upper plate 302 mounted on the substrate 301, a cavity 310 between the substrate 301 and the upper plate 302, an anode 307 and a cathode 309 and a solid electrolyte 306 in the cavity 310, an electron collector 305 placed under the anode 307, conductor 311 connected the electron collector 305, another conductor 308 connected to the cathode 309. The battery can be connected to an outside circuit via the conductors 311 and 308.

For convenient explanation, anode, solid electrolyte and cathode are selected the calcium, a molten eutectic mixture of LiCl—KCl, and K₂Cr₂O₇ are chosen in the case of FIG. 3. When the heat-activated microbattery 300 is heated up, the electrolyte 306 melts as shown FIG. 4. After that, the surface tension drive the melted electrolyte 312 to the anode 307 and the cathode 309, and finally the battery supply electrical energy due to the electrochemical reaction.

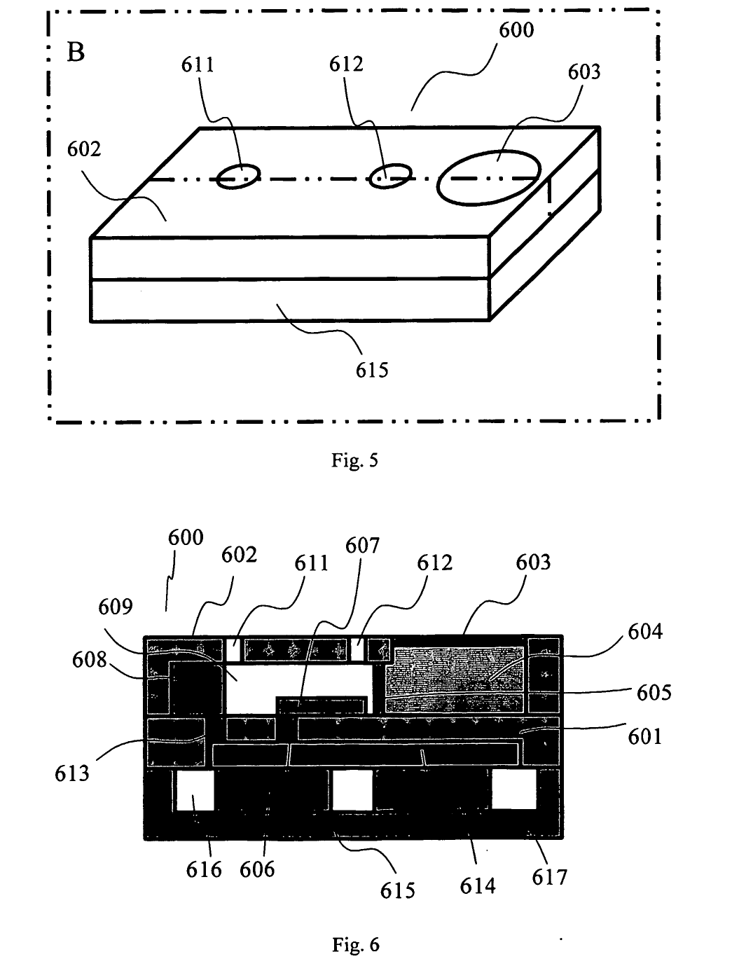

FIG. 5 shows a system 600 consisting of a microbattery, microchannels and an electrical circuit. FIG. 6 is a cross section along B of FIG. 5. The microchannels can be used for biomedical device such as diagnostic device or DNA chip to test the blood or a test liquid. In FIGS. 5 and 6, the substrate 601 is a silicon substrate of the microbattery. A microbattery is placed on the front side of the substrate 601, and an electrical circuits and microchannels are placed on the backside of the substrate 601. The front side of the substrate has a electron collector 607, anode 608, an electrolyte (sometimes including cathode) 604, an activation 603, a membrane 605, conductors 613, 606 connected to the electron collector 607 and anode 608 and a circuits 614. The backside of the substrate has an electrical circuit 614 connected the conductor 613 and 606, an lower plate 615 and microchannels 616 formed by space 617. 611 and 612, and 609 are air holes and a cavity, respectively.

When a user presses the activation button 603, the membrane 605 is broken. After that the surface tension drives the electrolyte 604 into the cavity 609, and the electrolyte contact the anode 608 and the electron collector 607. The generated electrons flow via the conductor 613 and 606 to supply electrical energy to the electrical circuit 614. The electrical circuit 614 activates biosensor (not drawn in the figures) placed in the microchannel 616 to examine a test liquid (not drawn in the figures).

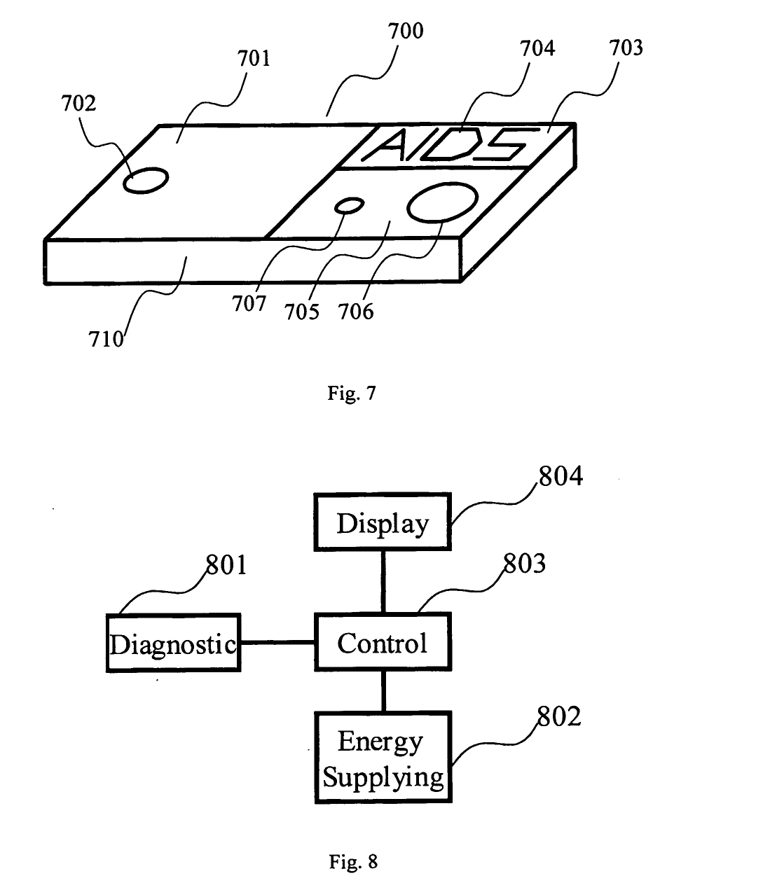

FIG. 7 shows another embodiment of the invention. A diagnostic chip 700 consists of an inlet 702 for test liquid such as blood, a diagnostic part 701 having a diagnostic device or biosensor inside (not drawn in the figure), a microbattery activation button 706, energy supplying part (microbattery) 705 with an air hole 707 and a display part 703 showing test result 704. The inside of the diagnostic chip 700 may have signal-processing unit (not drawn in the figure) such as an electrical circuit. FIG. 8 shows a signal flow of the inside of the diagnostic chip 700. When the activation button 706 is pressed, energy supplying part 802 supplies electrical energy to a diagnostic part 801 and a display part 804 via a control part 803. The diagnostic part tests a test liquid (not drawn in the figure) and sends a test result signal to the control part 803, and the control part processes the signal of the test result from the diagnostic part. Finally the display part 804 displays the test result that the user recognizes. Liquid crystal display, light emitting diode, etc can be used for the display.

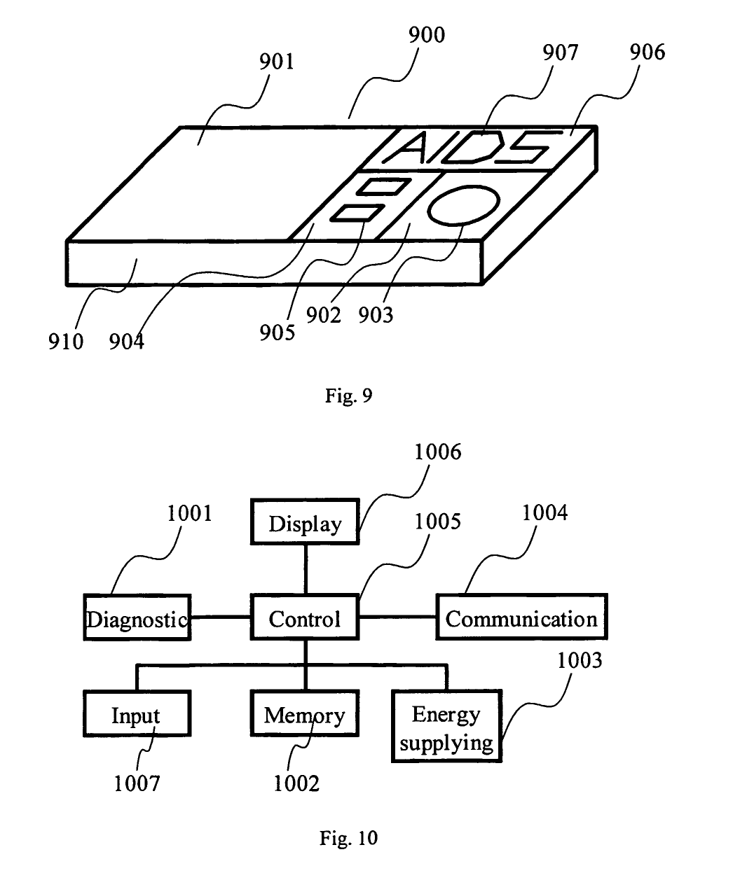

FIG. 9 shows an improved embodiment of the invention of FIG. 7. The diagnostic chip 900 consists of diagnostic part 901, an input means 905 such as key pads, an energy supplying part 902 with an activation button 903 and a display part 906 with a display means 907 such as LCD display.

FIG. 10 describes a signal flow of the invention shown in FIG. 9. Pressing the activation button 903 activates the energy supplying part 1003 to supply electrical energy, then a diagnostic part 1001 examines a test liquid and send test signal to the control part 1005, and finally the control part control the display part 1006 to display the test result. The input means 1007 can accept input of a user, and a memory part 1002 can offer memory required by the control part 1005. The memory part 1002 can also used to store temporary data during signal processing. A transmitting part 1004 can send a processed signal offered from the control part to an outside unit (not drawn in the figure) such as a computer. The transmitting part can be connected to outside by a conducting wire or an optical fiber. Wireless transmitting part can also be used to send the signal via the electromagnetic wave, the light and the ultrasonic wave. If needed, the signal for communication can be modulated or demodulated.

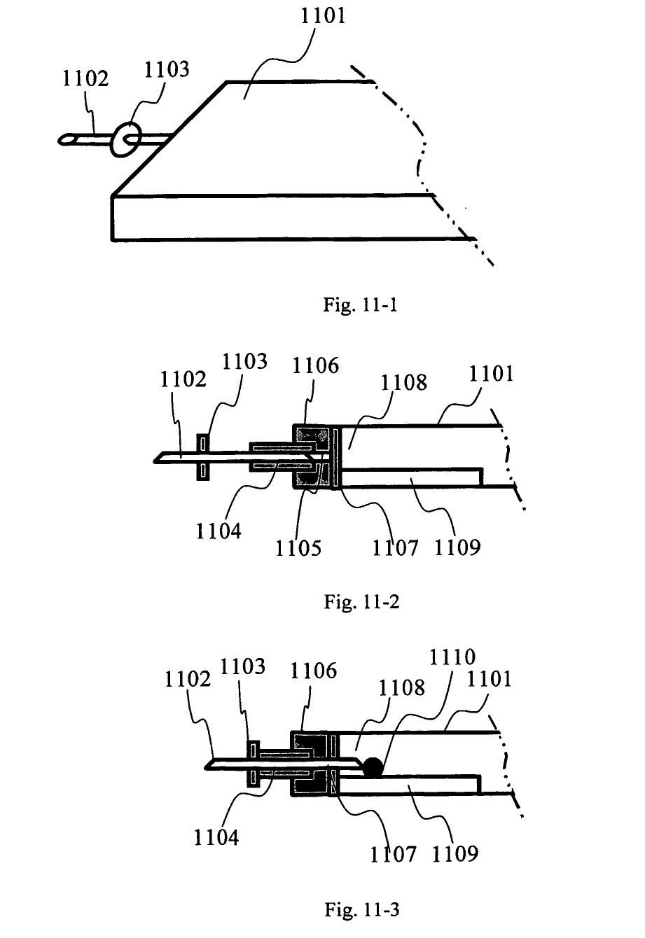

FIGS. 11-1, 11-2 and 11-3 shows drawings of diagnostic part 1101 of an embodiment of the invention that easily accepts the test liquid such as blood in FIG. 9. In this Figures, the diagnostic part has a needle 1102 for the test liquid. The needle may have a stopper 1103 that allows the needle 1102 to penetrate into the skin by a predetermined depth. In FIG. 11-2, the diagnostic part 1101 consists of a cavity 1108, a diagnostic mean 1109 which is adjacent to the cavity 1108, a needle 1102, and a stopper 1103 fixed on the needle 1102. The needle 1102 is connected to a cap 1106 via a guide 1104, and the cap has a path 1105 that can guide the needle 1102. There is a breaking means 1107 such as a membrane at the end of the cap 1106.

Only explanation for getting blood is given here because diagnose or test is same as shown in FIG. 9 after getting blood. The human skin is pricked with the needle 1102, then the stopper 1103 on the needle is pressed by the skin, after that the needle 1102 move into inside along the guide 1104 and the path 1105, finally the breaking means 1107 is torn as shown in FIG. 11-3. The blood of body can flow to the diagnostic means 1109 via the needle 1102. The cavity 1108 may be at the atmospheric pressure or vacuum to assist the blood flow.

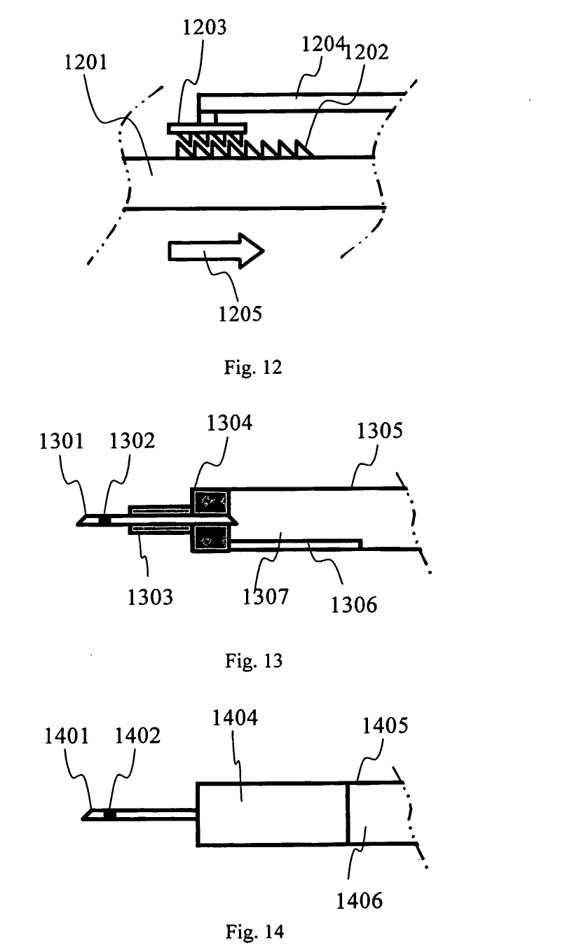

The embodiment of FIG. 11-2 has a potential problem; the needle 1102 maybe remain on the skin when the diagnostic part is taken out from the skin. In order to resolve this problem, FIG. 12 is presented describing the enlarged view of needle using saw teeth. When the skin is pricked with the needle 1102, the needle 1101 moves in the right direction (1205). The moved needle is prevented from moving in the left direction when it is taken out from the skin. The 1204 indicates the support of the saw teeth 1203.

FIG. 13 shows an embodiment of the invention where the breaking means 1302 is in a needle 1301. The needle 1301 fixed by a stopper 1303 has a soluble breaking means 1302. The stopper 1303 is connected to a cap 1304, the cap 1304 is connected to a diagnostic part 1305 that consists of a cavity 1307 and a diagnostic means 1306. When the human skin is pricked with the needle 1301, a chemical (for example water) in blood reacts to the breaking means 1302 and finally the blood can be transport from the human body to the cavity 1307 to supply blood to the diagnostic means 1306.

FIG. 14 shows an embodiment of the invention that has a different diagnostic part. A needle 1401 has a breaking 1402 inside the needle 1401, the needle 1401 is connected directly to a diagnostic means 1404, where there are the diagnostic means 1404 and a cavity 1406 in the diagnostic part 1405. To get easily blood, the cavity 1406 keeps vacuum. The diagnostic means 1406 is connected from the needle 1401 to the vacuum cavity 1406 via channel or tube (not drawn in the figure). When the human skin is pricked with the needle 1401, the breaking means 1402 is removed by chemical reaction to supply blood into the diagnostic means 1404. The vacuum of the cavity 1406 helps the blood to flow into the diagnostic 1404.

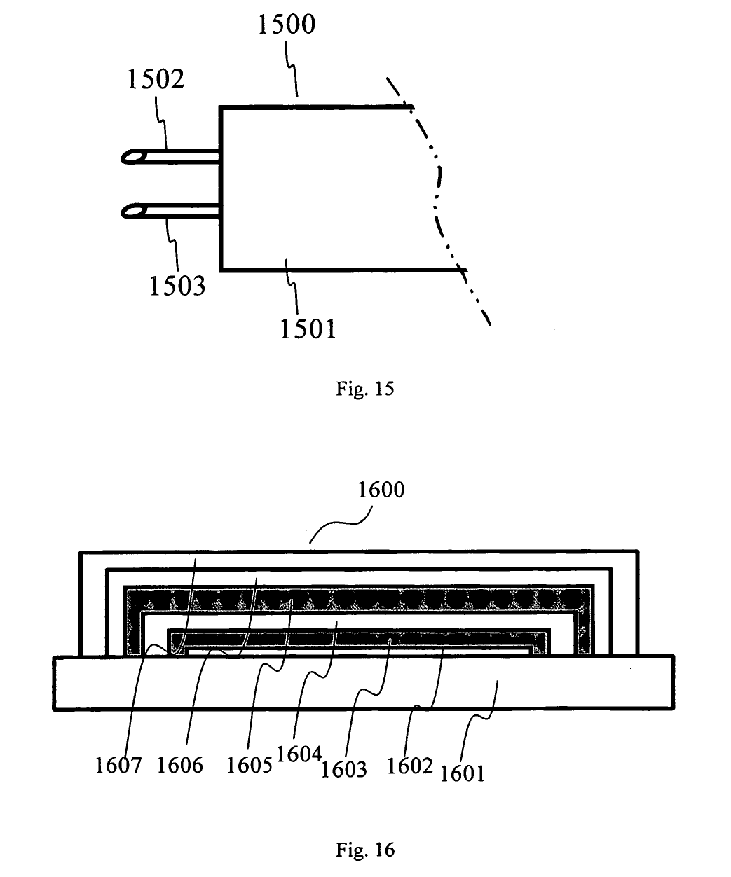

In FIGS. 11, 12, 13, and 14, only one needle was used to get blood from the human body. FIG. 15 is an embodiment of the invention that has another needle for a drug injection. In FIG. 15, a diagnostic and prescription part 1500 has an inspection needle 1502 and prescription needle 1503 connected to a diagnostic means 1501. Blood coming from the inspection needle 1502 is examined by an inspection means (not drawn in the figure) in the diagnostic and prescription part 1500. If needed, a drug can be supplied to the human body via the prescription needle 1503.

FIG. 16 shows an embodiment of the invention that is a stacked microbattery on the backside of a substrate of a diagnostic means 1600. The microbattery consists of a electron collector 1602 on the substrate 1601, an anode 1603, a separator 1604, cathode 1605 that absorbs an electrolyte, another electron collector 1606, and an insulation cap 1607. Working principle is similar to that of microbatteries already mentioned in this invention. If the battery 1600 is connected to a outside circuit (not drawn in the figure) via the electron collector 1602 and 1606, the electrolyte absorbed by the cathode 1605 flows to separator 1604 and reacts to the anode 1603 to supply electrons to the electron collector 1602. The supplied electron flows through the outside circuit to another electron collector 1606 and finally reacts to the cathode 1605. For a detail example, the microbattery can consist of zinc as the anode, cellophane film as separator, MnO₂ as cathode, zinc chloride as an electrolyte that is absorbed in the cathode. For more conductivity, carbon power can be added to the cathode.

To construct on the backside of the diagnostic chip, zinc-air battery can be used where electrical energy is generated when the zinc contacts air.

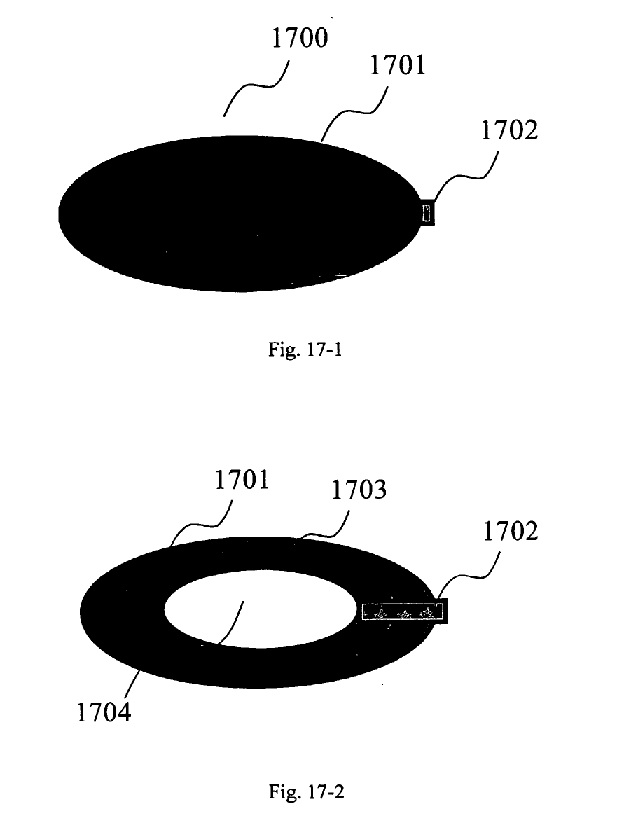

FIG. 17-1 shows an embodiment of the invention that is a drug delivery system 1700 activated by microbattery. FIG. 11-2 is a cross section of the drug delivery system of FIG. 11-1. The drug delivery system 1700 consists of a porous or fibrous material 1701 on the outside of the system, a drug delivery mean 1702, a microbattery 1703 already explained in this invention, and a control part 1704 to operate the drug delivery means 1702 if needed. The microbattery 1703 have no electrolyte at this time. After removing a protective layer (not drawn in the figure) such as plastic layer for protection, a person swallows the drug delivery system 1700 to deliver a drug to the body. The microbattery inside is activated by water or acid through the porous material 1701, in turn, activating the drug delivery system by supplying electrical energy to the control part 1704 and the drug delivery means 1702. In this case, the water-activated microbattery uses magnesium as the anode, silver chloride as the cathode. This battery is activated by water as the electrolyte that is in our body.

So far, several embodiments and details for the invention are explained. The invention includes embodiments that can be easily obtained from simple modification and combination of embodiments of the invention already shown. If a person understands this invention, he or she easily change anode, electrolyte, cathode, etc. For example, a water-activated microbattery consists of magnesium as the anode, and copper chloride or PbCl₂ as the cathode. This case is included in the present invention. Bigger battery using the same principle is also included in the invention. Placing a droplet of blood or water-including liquid on a diagnostic chip can also activate the microbattery of the invention and a system connected to the battery at the same time.

### ADVANTAGE OF THE INVENTION

If a battery is needed, pressing the activation button releases the sealed water or electrolyte to react to chemical such as anode, in turn, activating the microbattery of the invention. On a same substrate, microbattery, MEMS devices such as microchannels and electrical circuit can be fabricated. It means that the microbattery may be cheap and area-effective. The fabrication cost may be reduced because the microbattery and MEMS devices can be fabricated on a substrate at the same time. In this case, semiconductor technology such as CMOS process can be directly used to fabricate the microbattery, electrical circuit, MEMS devices on a substrate.

1. A microbattery including in combination:
a substrate;
an anode supplying electrons when the anode contact to an electrolyte;
a sealed liquid pocket including liquid mixture of an electrolyte and a cathode;
a pressing means to generate pressure in said sealed liquid pocket;
a breaking means that is easily torn or removed by the pressure generated in said liquid pocket;
conducting electron collectors collecting electron to assist cathodic reaction;
a cavity which said anode, said electron collector, and said breaking means contact to;
where surface tension drives said liquid mixture into said cavity after tearing said breaking means, then electrochemical reaction occurs to activate the microbattery.

2. The microbattery of claim 1, wherein said cavity has at least one air hole to remove air or gas inside said cavity when said microbattery is activated.

3. The microbattery of claim 1, wherein conductors are connected to said anode and electron collector to guide the generated electron to an outside circuit.

4. The microbattery of claim 1, wherein said anode, said electron collector, said sealed liquid pocket, said breaking means, said pressing mean, etc are fabricated on a substrate.

5. The microbattery of claim 1, wherein said cavity between said anode and said electron collector has a porous or fibrous absorber to absorb said liquid mixture.

6. The microbattery of claim 1, wherein said liquid mixture consists of the sulfuric acid and hydrogen peroxide.

7. The microbattery of claim 1, wherein said liquid mixture includes KOH.

8. A microbattery including in combination:
a substrate;
an anode supplying electrons when the anode contact to an electrolyte;
a cathode;
a sealed pocket including liquid electrolyte;
a pressing means to generate pressure in said sealed pocket;
a breaking means that is easily tom or removed by the pressure generated in said pocket;
a cavity which said anode, said electron collector, and said breaking means contact to;
where surface tension drives said liquid electrolyte into said cavity after tearing said breaking means, then electro-chemical reaction occurs to activate the microbattery.

9. The microbattery of claim 8, wherein conducting material is added to said cathode to reduce the internal resistance.

10. The microbattery of claim 8, wherein said cavity has at least one air hole to remove air or gas inside said cavity when said microbattery is activated.

11. The microbattery of claim 8, wherein a electron collector and conductor are connected to said anode and cathode to guide the generated electron to an outside circuit.

12. The microbattery of claim 8, wherein said anode, said cathode, said sealed pocket, said breaking means, said pressing mean, etc are fabricated on a substrate.

13. The microbattery of claim 8, wherein said cavity between said anode and said electron collector has a porous or fibrous absorber to absorb said liquid mixture.

14. The microbattery of claim 8, wherein said electrolyte is water.

15. The microbattery of claim 14, wherein said anode is magnesium and cathode is zinc chloride.

16. A microbattery including in combination:
a substrate;
an anode supplying electrons when the anode contact to an electrolyte;
a cathode;
a solid electrolyte that can be melted when the solid electrolyte is heated up;
a cavity in which said melted electrolyte can contact said anode and said cathode.
where surface tension drives said melted electrolyte into said cavity after heating up, then electrochemical reaction occurs to activate the microbattery.

17. A system including at least one microbattery consisting of:
a substrate;
an anode supplying electrons when the anode contact to an electrolyte;
a cathode;
a sealed pocket including liquid electrolyte;
a pressing means to generate pressure in said sealed pocket;
a breaking means that is easily tom or removed by the pressure generated in said pocket;
a cavity which said anode, said electron collector, and said breaking means contact to;
where the microbattery can supply electrical energy to said system after activation.

18. The system of claim 17, wherein said electrolyte includes said cathode.

19. The system of claim 17, wherein an area of said substrate has said microbattery, other area of said substrate has a diagnostic chip or system.

20. The system of claim 17, 18, and 19, wherein a side of said substrate has said microbattery, another side of said substrate has other part except said microbattery.

21. The system of claim 19, wherein said diagnostic chip consists of a display part, a control part, and a diagnostic part that is activated by said microbattery.

22. The system of claim 21, wherein said system has an input part such keypad to put data.

23. The system of claim 21, wherein a memory part and a communication part are added to process the data and communicate with outside.

24. The system of claim 23, wherein said system communicates with an outside system by using wireless transceiver.

25. The system of claim 21, wherein said system has a needle to extract a test liquid or blood.

26. The system of claim 25, wherein said system has a stopper to control the pricking depth.

27. The system of claim 26, there are a pair of saw teeth between the needle and a place facing the needle to preventing said needle from remaining on the skin when said system is taken out.

28. The system of claim 25, wherein said system has a breaking means or a membrane, then said braking means is torn or removed when the skin is pricked with said needle to obtain blood or test liquid inside.

29. The system of claim 25, wherein a soluble breaking means is inside said needle, said breaking means is removed to transport blood or test liquid inside.

30. The system of claim 25 to 30, wherein said diagnostic part is vacuum, then blood or test liquid can be easily transport into inside by the pressure difference when said breaking means is removed.

31. The system of claim 21, wherein in addition to said diagnostic part, said system has a prescription part to inject drug if needed.

32. The system of claim 31, wherein said system has one more needle for injection of drug.

33. A system including:
a substrate;
an energy consuming part consisting of electrical components, MEMS device, etc on a side of said substrate;
a power supplying part that generates electrical energy from an energy source such chemical and optical means.
where energy generated from said power supplying part flows to said energy consuming part.

34. The system of claim 33, wherein said power supplying part is battery converting chemical energy to electrical energy.

35. The system of claim 34, wherein surface tension drives an electrolyte from a position to another position to activate the battery.

36. The system of claim 35, wherein said electrolyte include a cathode material in it.

37. The system of claim 34, wherein said anode, said cathode, and said electrolyte are stacked on a substrate.

38. The system of claim 34, wherein said power supplying part is Zinc-Air battery to release electrical energy.

39. A system consisting of:
an actuating means;
a control means to control said actuating means;
an energy supplying means to supply electrical energy to said actuating means and said control means;
where an electro-chemical reaction in said energy supplying means occurs to supply electrical energy to said actuating means and said control means when an electrolyte is supplied.

40. The system of claim 39, wherein said electrolyte is water or a liquid including water.

41. The system of claim 39, wherein said electrolyte is an acid.

42. The system of claim 39, 40, and 41, wherein said system is drug delivery system in which an acid or water from human body activates energy supplying means to supply electrical energy to drug delivery device with said actuating mean, and said control means.
